(19) United States
(12) Patent Application Publication
(10) Pub. No.: US 2025/0081934 A1
(43) Pub. Date: Mar. 13, 2025

(54) PET FEEDER

(71) Applicant: SHANGHAI LIANCHONG INTELLIGENT TECHNOLOGY CO., LTD., Shanghai (CN)

(72) Inventors: Xiaolin ZHANG, Shanghai (CN); Hanzhi XIAO, Shanghai (CN)

(21) Appl. No.: 18/294,078

(22) PCT Filed: May 4, 2023
(86) PCT No.: PCT/CN2023/091959

§ 371 Date: Jan. 31, 2024

(30) Foreign Application Priority Data
Nov. 30, 2022 (CN) 202223200330.4
Apr. 18, 2023 (CN) 202320874922.X

(51) Int. Cl. A01K 5/02

(52) U.S. Cl. CPC A01K 5/0291

(57) ABSTRACT

A pet feeder includes a feeding bowl and a plurality of housing cells, wherein the plurality of housing cells are sequentially connected and are rotatable synchronously against a common axial line; a fixed bowl cover is provided at an opening of the feeding bowl, a first opening is opened in the fixed bowl cover, the first opening corresponds only to any of the plurality of housing cells; the pet feeder further includes a movable bowl cover jointly rotatable along with the plurality of housing cells; the movable bowl cover includes at least one open area corresponding to the first opening and at least one shelter covering the first opening, when the movable bowl cover rotates along with the plurality of housing cells, any of the plurality of housing cells and the at least one open area correspond jointly to the first opening.

### TECHNICAL FIELD

The present invention relates to the technical field of pet products, especially a pet feeder.

### BACKGROUND TECHNOLOGY

A pet feeder is a device for housing pet food for pets to eat, and a pet feeder comprises at least a feeding bowl. There are two types of pet feeders currently commercially available; one is a simple pet feeder, with a permanently open access for pets to eat at any time, for this type of pet feeder, users are not informed of how much the pets eat, and the food is susceptible to deteriorate; another one is an automatic feeder, with which the pets can dine at a fixed time for a fixed amount, however, requirements are posed for the food, only dry food with a low humidity or freeze-dried food can be served with this feeder, in addition, as the feeder is always open with food in it, the food is liable to deteriorate. In view of the foregoing problems, corresponding improvements have been made in the prior art, for example, a Chinese utility model patent with a publication date of Apr. 23, 2019, publication number of CN208768699U discloses a pet feeding device, comprises a feeding casing, a bowl, a fresh-keeping cover, a single chip information processing module, and an infrared sensor, the bowl is provided in the feeding casing, the infrared sensor is provided at a front end of the feeding casing, the fresh-keeping cover is covered on the bowl, the fresh-keeping cover is openable, and configured to sense a pet or a human and send signals to the single chip information processing module, the single chip information processing module controls to open or close the fresh-keeping cover, with the technical solution in this utility model patent, the pet food can be maintained fresh, the appetite of the pet can be sustained, and the food is not wasted. However, the deficiency of this technical solution is that: with only one bowl and a fresh-keeping cover to control open and close thereof, different types of food cannot be placed in the present feeding device, and automatic control of open and close of corresponding types of food cannot be achieved.

For another example, a Chinese utility model patent with a publication date of Jun. 2, 2010 and a publication number of CN201491588U discloses an automatic pet feeding device, wherein, the automatic pet feeding device comprises a base plate and a rotating cover, an electronic box is placed at a center of the base plate, an area between the electronic box and an outer surface of the base plate is cut evenly into a plurality of food cells; the electronic box comprises a motor, a battery box and a controller, three timing keys are provided at the outer surface of the base plate, wherein the controller comprises a single chip unit, the three timing keys are connected with an input interface of the controller, the input interface of the controller is connected with the motor; a hole corresponding to a rotating shaft of the motor is opened at a center of the rotating cover, and a feeding window perpendicular to the plurality of food cells and with a size and shape the same as any of the plurality of food cells is opened in the rotating cover. During use, put food in the plurality of food cells. First of all, leave one of the plurality of food cells empty without putting any food there, thereafter, put into the other food cells food for the first meal, the second meal, the third meal etc. sequentially, and the amount can be dependent on the eating habit of the pet, and in the meanwhile, by not putting any food in the food cell, one meal may be omitted. The technical solution in this utility model is of high utility, and can realize automatic feeding of the pets, different amounts of food can be placed for each meal in advance, and feeding interval time can be set according to health conditions of the pet, however, the defect of this technical solution is that: it is necessary to leave one of the food cells empty, so the space is wasted and the total amount of food placed in the feeding device is reduced.

### SUMMARY OF THE INVENTION

To address the problem of the space waste of the corresponding pet feeder, the present invention provides a pet feeder. And the technical solution is that:
A pet feeder, comprises a feeding bowl and a plurality of housing cells, wherein the plurality of housing cells are sequentially connected and are rotatable synchronously against a common axial line;
A fixed bowl cover is provided at an opening of the feeding bowl, a first opening is opened in the fixed bowl cover, the first opening corresponds only to any of the plurality of housing cells;
The pet feeder further comprises a movable bowl cover jointly rotatable along with the plurality of housing cells;
the movable bowl cover comprises at least one open area corresponding to the first opening and at least one shelter covering the first opening, when the movable bowl cover rotates along with the plurality of housing cells, any of the plurality of housing cells and the at least one open area correspond jointly to the first opening, or the at least one shelter of the movable bowl cover corresponds to the first opening.

With the foregoing technical solution, with the first opening provided in the fixed bowl cover at the opening of the feeding bowl, by adjusting the first opening to be corresponding to any of the plurality of housing cells, rotating the plurality of housing cells and the movable bowl cover, providing the at least one open area in the movable bowl cover corresponding to the first opening, when both any of the plurality of housing cells and the at least one open area of the movable bowl cover correspond to the first opening of the fixed bowl cover, the any of the plurality of housing cells is opened, so as to provide food or other articles provided in the any of the plurality of housing cells to a pet; furthermore, the movable bowl cover is further provided with the at least one shelter covering the first opening, so that, when the at least one shelter of the movable bowl cover corresponds to the first opening of the fixed bowl cover, the plurality of housing cells are closed by the at least one shelter, the pet is isolated from the food or the other articles; therefore, without leaving any of the plurality of housing cells empty, the purpose of isolation is realized, each of the plurality of housing cells can be used, the spatial usage rate is high and the total housing amount is improved.

In some embodiments, a number of the plurality of housing cells is configured to be N, the at least one open area of the movable bowl cover is provided to be one, and a rotation angle ratio between the movable bowl cover and the plurality of housing cells is N:1.

In some embodiments, a weighing mechanism is provided underneath the feeding bowl, wherein the weighing mechanism comprises a load cell, a tray holder is provided above the load cell, a weighing tray is provided on the tray holder, and the weighing tray is configured to bear the feeding bowl.

In some embodiments, the present invention further comprises at least one grating sensor, and the at least one grating sensor is configured to detect an orientation of the movable bowl cover.

In some embodiments, the present invention further comprises at least one infrared sensor, wherein the infrared sensor is configured to detect a position of the pet.

In some embodiments, the present invention further comprises a fence surrounding the feeding bowl, an opening is provided in the fence and the opening corresponds to the first opening of the fixed bowl cover.

In some embodiments, the plurality of housing cells comprises disposable housing cells.

### BRIEF DESCRIPTION OF DRAWINGS

FIG. 1 is a structural diagram showing the present invention, wherein, the first housing cell is opened;

FIG. 2 is an exploded diagram showing the present invention;

FIG. 3 is a structural diagram showing a gear assembly in the drive mechanism according to the present invention;

FIG. 4 is a structural diagram showing a position detection mechanism according to the present invention;

FIG. 5 is a structural diagram showing a weighing mechanism according to the present invention.

Specifically, 100 base plate; 101 battery slot; 110 battery cover; 200 main casing; 210 load cell; 211 tray holder; 212 weighing tray; 2121 prolonged pole; 220 feeding bowl; 221 first housing cell; 222 second housing cell; 223 interpolated cylinder; 224 rotation cylinder; 230 movable bowl cover; 231 first reinforcing ring; 232 rotation bar; 240 fixed bowl cover; 241 second reinforcing ring; 250 drive mechanism; 251 drive gear; 252 first driven gear; 253 second driven gear; 254 third driven gear; 255 fourth driven gear; 260 sensor body; 261 grating; 2611 first optical aperture; 2612 second optical aperture; 2613 third optical aperture; 2614 third optical aperture; 2615 fifth optical aperture; 2616 sixth optical aperture; 270 main control board; 271 signal receiver; 272 infrared sensor; 273 key; 300 fence; and 310 opening.

### EMBODIMENTS

Hereinafter, the technical solutions in the embodiments of the present invention will be described clearly and completely in conjunction with the drawings of the embodiments of the present invention.

In the description of the present invention, it shall be comprehensible that, positional or spatial relationships indicated by terms “central”, “longitudinal”, “transverse”, “upper”, “lower”, “front”, “rear”, “left”, “right”, “vertical”, “horizontal”, “top”, “bottom”, “inner” and “outer” are based on the positional or spatial relationships shown in the drawings, which are only used to ease description of the present invention rather than to indicate or imply that the device or element must have a specific orientation, be made and operated in a specific orientation, and shall therefore not be construed as limitation on the protection scope of the present invention. furthermore, terms “first” or “second” are only employed for description and shall not be understood to indicate or imply relative importance or indicate the number of the technical features. Therefore, when restricted by “first” or “second” one or more such features can be expressly or implicitly included. In the description of the present invention, unless indicated otherwise, the content of “a plurality of” is two or more.

In the description of the present invention, it shall be noted that, unless indicated otherwise expressly, terms “installation”, “connection” or “joint” shall be understood in a broad sense, for example, the connection can be fixed connection or detachable connection or integral connection; the connection can be mechanical connection or electric connection; the connection can be direct connection or connection via intermediate media; the connection can also be internal communication of two elements. For those of ordinary skill in the art, specific meanings of the foregoing terms in the present invention can be comprehended in specific cases.

Vertical direction is perpendicular to a horizontal plane, and the present product when disposed in common conditions the installation plane is parallel to the horizontal plane.

A central line of the feeding bowl comprises a line passing a center point of an opening of the feeding bowl and is perpendicular to the horizontal plane and can also be an axial line rotating along with the plurality of housing cells synchronously.

### Embodiment 1

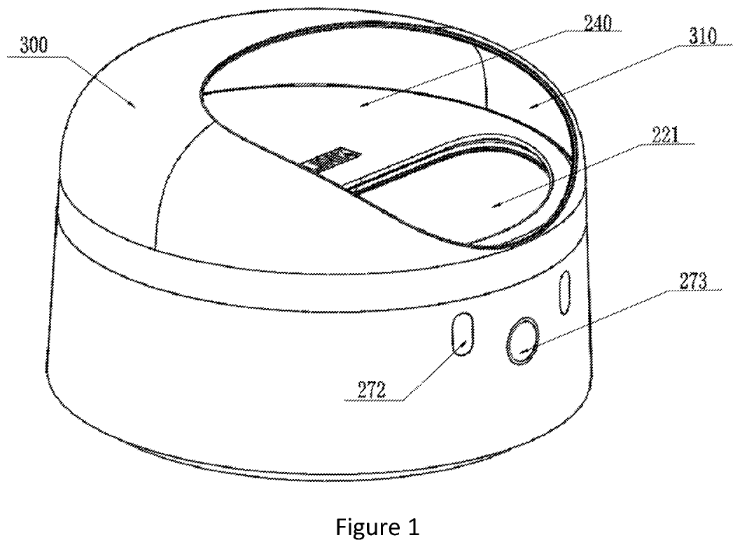

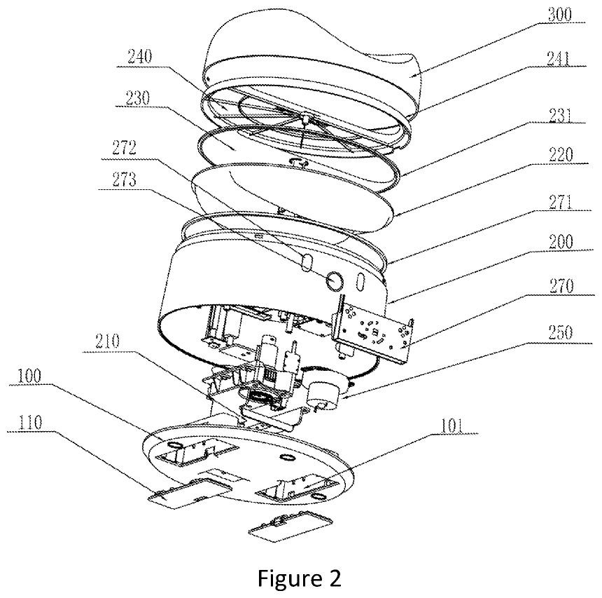

As shown in FIGS. 1 and 2, a pet feeder, comprises a base plate 100 and a main casing 200 provided on the base plate 100, and a feeding bowl 220 is provided on the main casing 200.

A plurality of housing cells are provided in the feeding bowl 220, the plurality of feeding cells are sequentially connected and rotate along with the same axial line synchronously. The plurality of housing cells can be provided to be two or three housing cells, and the plurality of housing cells can have the same dimension or different dimensions.

A fixed bowl cover is provided for the feeding bowl, a first opening is opened on the fixed bowl cover, the first opening corresponds only to any of the plurality of housing cells, that is, a dimension of the first opening is not bigger than a dimension of a smallest one of the plurality of housing cells, so that, for feeding once, only one of the plurality of housing cells is opened, the pet has access to only the food in the one of the plurality of housing cells, without access to food in any other housing cells.

The pet feeder further comprises a movable bowl cover that rotates along with the plurality of housing cells synchronously.

The movable bowl cover comprises at least one open area corresponds to the first opening and at least one shelter covering over the first opening, furthermore, when the movable bowl cover rotates along with the plurality of housing cells synchronously, any of the plurality of housing cells and the at least one open area correspond at the same time to the first opening, the any one of the plurality of housing cells is opened so as to provide the pet with the food or other articles provided in the any one of the plurality of housing cells, or, by corresponding the at least one shelter of the movable bowl cover with the first opening, all of the plurality of housing cells are closed by the at least one shelter, so as to separate the pet and the food or other articles, so it is not necessary to leave any of the plurality of housing cells empty to isolate the pet and the food, all of the plurality of housing cells are utilized, spatial usage rate is improved and so is the housing amount.

A number of the plurality of housing cells is provided to N, the at least one open area of the movable bowl cover is provided to be only one, and a rotation angle rate between the movable bowl cover and the plurality of housing cells is N:1.

For example, the dimension of the plurality of housing cells is the same, and initially, one of the plurality of housing cells is open, mark the open housing cell as cell 1, and sequentially cell 2 . . . , cell n . . . , cell N, the specific rotating angle can be: open the cell n, the rotation angle of the plurality of housing cells is 360°/N*(n−1), and the rotation angle of the movable bowl cover is 360°/N*(n−1)*N; close the plurality of housing cells, the rotation angle of the plurality of housing cells is 360°/N/N, the rotation angle of the movable bowl cover is 360°/N; close the open cell and mark as 1, the rotation angle required for opening the cell 1 is, the rotation angle of the movable bowl cover is (360°−360°/N/N)*N, open the cell n, the rotation rate of the plurality of housing cells is 360°/N*(n−1)−360/N/N and the rotation rate of the movable bowl cover is [360/N*(n−1)−360/N/N] *N.

Hereinafter a detailed description will be given taken as an example two equal-sized housing cells, a first housing cell 221 and a second housing cell 222, and the at least one open area of the movable bowl cover is only one.

The movable bowl cover 230 and the fixed bowl cover 240 are stacked over the feeding bowl, it shall be understood that, the fixed bowl cover 240 is not generally rotatable, while the movable bowl cover 230 is rotatable, the movable bowl cover 230 and the fixed bowl cover 240 are generally semi-circular, when the movable bowl cover 230 and the fixed bowl cover 240 coincide vertically, the feeding bowl 220 is open to the largest extent for the pet to eat, when the movable bowl cover 230 and the fixed bowl cover 240 coincide to a less extent vertically, the feeding bowl 220 is completely closed, the food in the feeding bowl is isolated from the foreign environment, so as to maintain the food fresh, in addition, with the present pet feeder, by controlling the relative position of the movable bowl cover 230 and the feeding bowl 220, the pet dining rate is automatically controlled, so as to realize pet dining control.

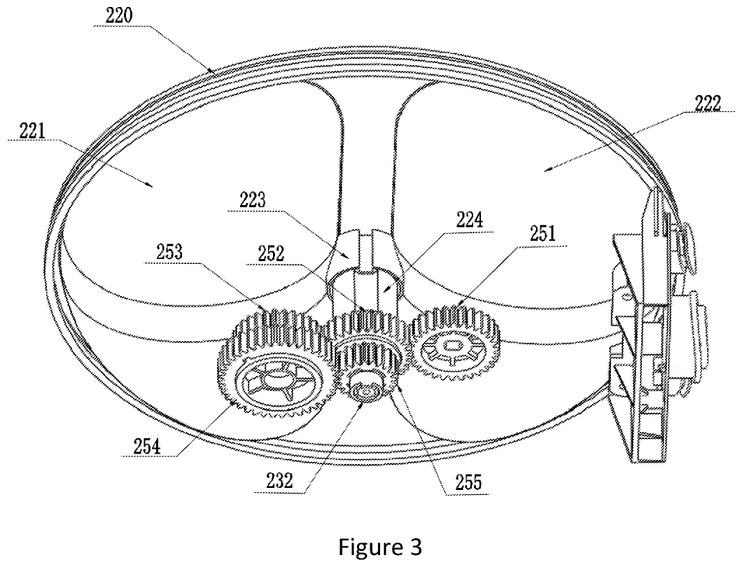

As shown in FIG. 3, the feeding bowl 220 comprises a first housing cell 221 and a second housing cell 222 that are symmetrically provided, so as to place different kinds of food, for example, daily food for the pet comprises generally dried food with a low humidity and canned food with a high humidity, and by providing different kinds of food, the dining wish of the pet can be raised. Configuration of the first housing cell 221 and the second housing cell 222 is suitable for families with more than one pet, especially, when a pet need prescription diet, both common diet and prescription diet can be provided and in collaboration with recognition of pets food supplies are given to avoid incorrect diet. The first housing cell 221 and/or the second housing cell 222 are preferably disposable housing cells, so that they can be replaced directly without cleaning, use convenience and hygiene conditions are improved.

At this time, both the movable bowl cover 230 and the fixed bowl cover 240 can be adaptive to the first housing cell 221 and/or the second housing cell 222, that is, dimensions of the movable bowl cover 230 and the fixed bowl cover 240 can cover the first housing cell 221 and the second housing cell 222, and when the movable bowl cover 230 coincides with the fixed bowl cover 240 on a vertical direction, the first housing cell 221 or the second housing cell 222 can be basically opened. To open the first housing cell 221 and the second housing cell 222, a drive mechanism is connected with the movable bowl cover 230, the drive mechanism 250 pivots against a central line of the feeding bowl 220 horizontally relative to the fixed bowl cover 240, the drive mechanism 250 is further connected with the feeding bowl 220 to pivot against the feeding bowl 220 horizontally relative to the movable bowl cover 230, and the rotation angle ratio between the movable bowl cover 230 and the feeding bowl 220 is 2:1. It shall be understood that, to realize control of the feeding bowl 220 to completely open the first housing cell 221 or the second housing cell 222 with the drive mechanism, an initial status of the present pet feeder is that, the movable bowl cover 230 and the fixed bowl cover 240 coincide on the vertical direction, and the first housing cell 221 or the second housing cell 222 are basically open (hereinafter an example is given with the first housing cell 221 to be completely open, as shown in FIG. 1), with automatic control of the drive mechanism 250, to close the pet feeder, turn the movable bowl cover 230 for ½ round, turn the feeding bowl 220 for ¼ round until a half of the first housing cell 221 and a half of the second housing cell 22 is located underneath the movable bowl cover 230; thereafter, to open the pet feeder, turn the movable bowl cover 230 for ½ round until the initial assembly status, turn the feeding bowl 220 for ¼ round until the second housing cell 222 is completely open; . . . so as to achieve automatic feeding of the pet feeder.

To improve rotation stability of the movable bowl cover 230, the movable bowl cover 230 is preferably provided in a first reinforcing ring 231, and the movable bowl cover 230 and the first reinforcing ring 231 are integrally made, as shown in FIG. 2, the movable bowl cover 230 is basically semi-circular adaptive to the housing cells of the feeding bowl 220, the movable bowl cover 230 is provided inside the first reinforcing ring 231, and the movable bowl cover 230 is connected with the first reinforcing ring 231. The fixed bowl cover 240 can be provided in a second reinforcing ring 241 and the fixed bowl cover 240 and the second reinforcing ring 241 are integrally formed, which resembles the case of the movable bowl cover 230 and the first reinforcing ring 231. The second reinforcing ring 241 can be extended for a certain distance downwards so that the fixed bowl cover 240 is closed over the main casing 200.

To drive the movable bowl cover 230 and the feeding bowl 220 to rotate with the drive mechanism 250, the drive mechanism 250 comprises a dual-drive assembly to control separately, and also engagement of a single drive component and a gear assembly can be used to realize control. In the present embodiment, the single drive component is used and the drive component comprises a motor, as shown in FIG. 3, the drive mechanism 250 comprises a motor (not shown in the drawings), a gear assembly is connected at an output shaft of the motor, a gear among the gear assembly is connected with the movable bowl cover 230 and drives the movable bowl cover 230 to rotate synchronously, it shall be understood that, no matter how many housing cells there are, the present drive mechanism 250 can be used to realize synchronous rotation, specifically, in the present embodiment, a transmission ratio between the gear connected with the feeding bowl 220 and the gear connected with the movable bowl cover 230 is 1:2. Specifically, the gear assembly comprises a drive gear 251 co-axially connected with the output shaft of the motor (not shown in the drawings), the drive gear 251 engages with a first driven gear 252, the first driven gear 252 engages with a second driven gear 253, the second driven gear 253 is co-axially connected with a third driven gear 254, the third driven gear 254 engages with a fourth driven gear 255, a transmission ratio between the drive gear 251, the first driven gear 252, and the second driven gear 253 is 1:1:1, and a transmission ratio between the third driven gear 254 and the fourth driven gear 255 is 1:2. The first driven gear 252 is connected with the feeding bowl 220 and drives the feeding bowl 220 to rotate synchronously, alternatively, the first driven gear 252 is co-axially connected with a rotation cylinder 225, and the rotation cylinder 225 is co-axially connected with the feeding bowl 220. The fourth driven gear 255 is connected with the movable bowl cover 230 and drives the movable bowl cover 230 to rotate synchronously, alternatively, a rotation bar 232 is provided in the rotation cylinder 224, the fourth driven gear 255 is co-axially connected with an end of the rotation bar 232, another end of the rotation bar 232 is connected with the movable bowl cover 230. Alternatively, a sleeve 223 is provided in a center of the feeding bowl 220, the rotation cylinder 224 is interpolated in the sleeve 223 and drives the sleeve 223 to rotate synchronously; alternatively, a sleeve can be provided at a center of the movable bowl cover 230, the rotation bar 232 is interpolated in the sleeve and drives the sleeve to rotate synchronously.

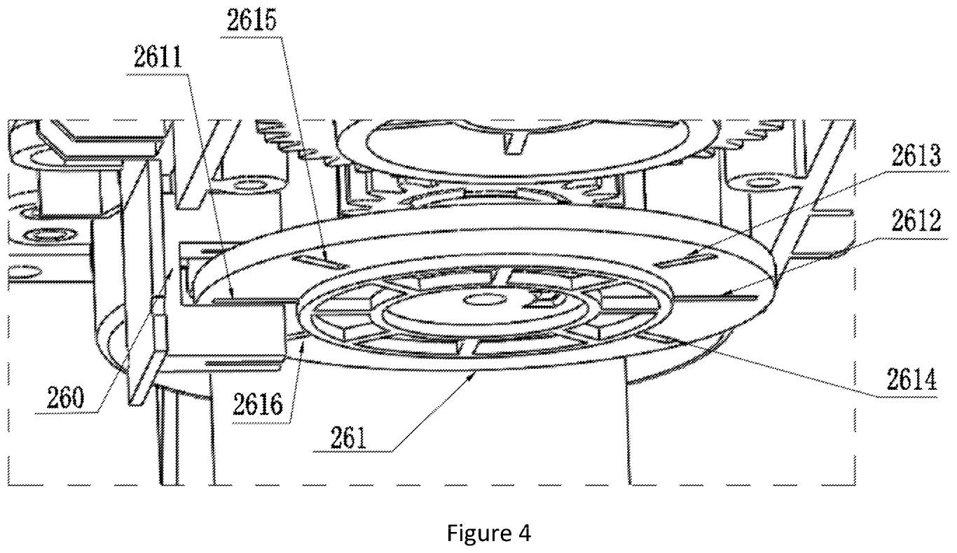

The present pet feeder can further comprises at least one grating sensor, wherein the at least one grating sensor is configured to detect a position of the movable bowl cover 230, and realize precise rotation of the movable bowl cover 230 so as to control the motor, at this time, the drive mechanism 250 further comprises a drive controller. Those skilled in the art know that, a grating sensor comprises a sensor body 250 and a grating 261, the sensor body 260 comprises an emitting end and a receiving end that are oppositely provided, at least one optical aperture is provided in the grating 261, the grating 261 rotates between the emitting end and the receiving end, when the at least one optical aperture is rotated to in between the emitting end and the receiving end, that is, rotated to a detection area of the sensor body 260, the detection of the grating 261 is realized, so is the detection of the movable bowl cover 230. Specifically, as shown in FIG. 4, the rotation bar 232 is connected with the movable bowl cover 230, the at least one grating sensor is provided close to the rotation bar 232, the grating 261 and the rotation bar 232 are co-axially connected, a first optical aperture 2611 and a second optical aperture 2612 are opened at the grating 261 corresponding to both ends of a closing route of the movable bowl cover 230, in the present embodiment, both the movable bowl cover 230 and the fixed bowl cover 240 are basically semi-circular, thus the first optical aperture 2611 and the second optical aperture 2612 are symmetrically provided at a center of the grating 261. The first optical aperture 2611 and the second optical aperture 2612 can be used to judge the status of the feeding bowl 220, that is, the status of the movable bowl cover 230, it shall be understood that, the fixed bowl cover 240 is provided in between the first optical aperture 2611 and the second optical aperture 2612. A third optical aperture 2613 is further opened in the grating 261, and the third optical aperture 2613 is located at the closing route of the movable bowl cover 230. Specifically, when the rotation bar 232 drives the movable bowl cover 230 to rotate from an open state to a close state (that is, the movable bowl cover 230 rotates along the closing route), with the rotation of the grating 261, the first optical aperture 2611, the third optical aperture 2613 and the second optical aperture 2612 are sequentially located at the detection position of the sensor body 260. Further, when the sensor body 260 detects the third optical aperture 2613, the drive controller controls the motor to stop for some time and restart, and/or the motor comprises a variable-speed motor, when the detection position of the sensor body 260 is in between the third optical aperture 2613 and the second optical aperture 2612, the drive controller controls the motor to run in a reduced speed. For the present pet feeder, by pausing the motor or running the motor in a reduced speed, time is provided for a head or jaw of the pet to leave the feeding bowl 220 and avoid injury of the pet. An included angle between the third optical aperture 2613 and the second optical aperture 2612 is a sharp angle, that is, the third optical aperture 2613 is close to a closing end of the closing route of the movable bowl cover 230, as the grating 261 rotates synchronously with the movable bowl cover 230, at this time, an included angle between the movable bowl cover 230 and the fixed bowl cover is also a sharp angle, the movable bowl cover 230 is close to be closed. The included angle between the third optical aperture 2613 and the second optical aperture 2612 is preferably 30° to 50° so that a sufficient distance is provided for leave of the jaw of the pet.

To realize accurate close of the movable bowl cover 230, a reduced aperture is provided respectively in front of the first optical aperture 2611 and the second optical aperture 2612, so that when the movable bowl cover 230 is found to rotate to an appropriate position, the drive controller controls the motor to make appropriate changes, specifically, when the detection position of the sensor body 260 is located in between the reduced aperture and the first optical aperture 2611 and/or the second optical aperture 2612, the drive mechanism 250 runs at a reduced speed. The reduced aperture in front of the second optical aperture 2612 can coincide with the third optical aperture 2513, and in the present embodiment, the reduced aperture comprises the third optical aperture and a sixth optical aperture. It shall be understood that, a front portion refers to a side in front of a rotation direction of the grating 261.

The fourth optical aperture 2614 and the fifth optical aperture 2615 are opened in the grating 261, the fourth optical aperture 2614 and the fifth optical aperture 2615 are respectively provided behind the second optical aperture 2612 and the first optical aperture 2611, so as to sense a position of an intermediate state of the rotation of the movable bowl cover 230.

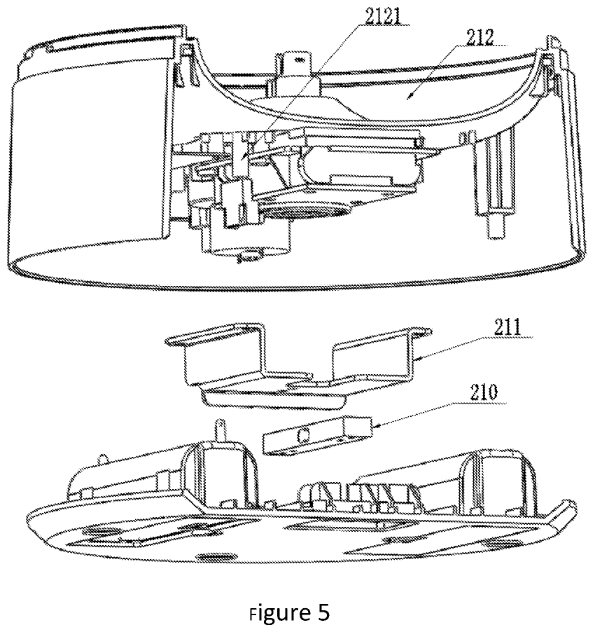

As shown in FIG. 5, a weighing mechanism is provided underneath the feeding bowl 220 so as to know the pet dining amount. The weighing mechanism comprises a load cell 210, a tray holder 211 is provided on the load cell 210, a weighing tray 2121 is provided on the tray holder 211, the weighing tray 212 is configured to bear the feeding bowl 220. The weighing tray 212 is integrally formed along with the main casing 200, and the load cell 210 is provided on the base plate 100, it shall be comprehensible that, at this time, the main casing 200 and the base plate 100 are not fixed, a gap is reserved in between them for weighing. In the present embodiment, to ease installation of the other components, a prolonged pole 2121 is provided underneath the weighing tray 212, and the weighing tray 212 is connected with the tray holder 211 via the prolonged pole 2121.

A signal receiver 271 for receiving an ID information of the pet is provided in the base plate or the main casing 200. For example, the pet wears a neck ring with an electronic tag, in the electronic tag the ID information of the pet is recorded, the signal receiver 271 comprises a reader so that for a family with more than one pet, the dining conditions of all the pets can be known, or different diets can be fed to different pets. The present pet feeder further comprises a fence 300 surrounding the feeding bowl 220, an opening 310 is provided in the fence 300, the opening 310 is far from the fixed bowl cover 240 so as to make it convenient for the pet to eat, and avoid the pet to touch the bowl covers to affect the functioning of the pet feeder, in the meanwhile, a size of the opening 310 can be configured to be only sufficient for allowing a pet to eat at one time, so that in conjunction with the weighing mechanism, the eating amount of each pet can be known accurately.

The present pet feeder further comprises an infrared sensor 272, wherein the infrared sensor 272 is configured to detect positions of the pets. The infrared sensor 272 can be provided on the main casing 200. The present pet feeder further comprises a main control board 270, keys 273 connected with the main control board 270 are provided on the base plate 100 or the main casing 200 so as to realize manual control without loading the mobile app. It shall be understood that, the main control board 270 can be connected with the drive mechanism 250, the weighing mechanism, the optical sensor, the signal receiver 271 and the infrared sensor so to realize intelligent control of the pet feeder.

The present pet feeder further comprises a power supply mechanism, wherein the power supply mechanism is configured to supply power for the pet feeder, the power supply mechanism comprises at least one battery and at least one port for connecting with foreign power supply, generally, the pet feeder is energized by municipal power supply via a charger, when the power supply is not available, the pet feeder is energized via the at least one battery. The at least one battery can be installed in the base plate 100, specifically, the base plate 100 comprises a battery slot 101 and a battery cover 110 is detachably connected with the battery slot 101.

Furthermore, it shall be comprehensible that, apparently, the embodiments given here are only some of the embodiments of the present invention, rather than all. Based on the embodiment given here, all other embodiments obtained by those of ordinary skill in the art without paying creative effort fall into the protection scope of the present invention.

1. A pet feeder, comprises a feeding bowl and a plurality of housing cells, wherein the plurality of housing cells are sequentially connected and are rotatable synchronously against a common axial line;
a fixed bowl cover is provided at an opening of the feeding bowl, a first opening is opened in the fixed bowl cover, the first opening corresponds only to any of the plurality of housing cells;
the pet feeder further comprises a movable bowl cover jointly rotatable along with the plurality of housing cells;
the movable bowl cover comprises at least one open area corresponding to the first opening and at least one shelter covering the first opening, when the movable bowl cover rotates along with the plurality of housing cells, any of the plurality of housing cells and the at least one open area correspond jointly to the first opening, or the at least one shelter of the movable bowl cover corresponds to the first opening.
the movable bowl cover is further provided with the at least one shelter covering the first opening, so that, when the at least one shelter of the movable bowl cover corresponds to the first opening of the fixed bowl cover, the plurality of housing cells are closed by the at least one shelter, the pet is isolated from the food or the other articles; therefore, without leaving any of the plurality of housing cells empty, the purpose of isolation is realized, each of the plurality of housing cells can be used, the spatial usage rate is high and the total housing amount is improved.

2. The pet feeder according to claim 1, wherein a number of the plurality of housing cells is configured to be N, the at least one open area of the movable bowl cover is provided to be one, and a rotation angle ratio between the movable bowl cover and the plurality of housing cells is N:1.

3. The pet feeder according to claim 1, wherein, a dimension of the plurality of housing cells is equal.

4. The pet feeder according to claim 1, wherein, the plurality of housing cells rotate along with the movable bowl cover synchronously via a gear assembly, wherein the gear assembly is connected with a drive component.

5. The pet feeder according to claim 1, wherein, the gear assembly comprises a drive gear co-axially connected with the output shaft of the motor, the drive gear engages with a first driven gear, the first driven gear engages with a second driven gear, the second driven gear is co-axially connected with a third driven gear, the third driven gear engages with a fourth driven gear, the first driven gear is connected with the plurality of housing cells and drives the plurality of housing cells to rotate synchronously, and the fourth driven gear is connected with the movable bowl cover and drives the movable bowl cover to rotate synchronously.

6. The pet feeder according to claim 5, wherein, the first driven gear is co-axially connected with a rotation cylinder, and the rotation cylinder is co-axially connected with the feeding bowl, the fourth driven gear is connected with the movable bowl cover and drives the movable bowl cover to rotate synchronously, an end of the rotation bar is connected co-axially with the fourth driven gear and another end thereof is connected with the movable bowl cover.

7. The pet feeder according to claim 5, wherein, a transmission ratio between the drive gear, the first driven gear, and the second driven gear is 1:1:1 and a transmission ratio between the third driven gear and the fourth driven gear is 1:N.

8. The pet feeder according to claim 1, wherein, a weighing mechanism is provided underneath the feeding bowl, wherein the weighing mechanism comprises a load cell, a tray holder is provided above the load cell, a weighing tray is provided on the tray holder, and the weighing tray is configured to bear the feeding bowl.

9. The pet feeder according to claim 1, wherein, the pet feeder further comprises at least one grating sensor, and the at least one grating sensor is configured to detect an orientation of the movable bowl cover.

10. The pet feeder according to claim 1, wherein, the pet feeder further comprises at least one infrared sensor, wherein the infrared sensor is configured to detect a position of the pet.

11. The pet feeder according to claim 1, wherein, the pet feeder further comprises a fence surrounding the feeding bowl, an opening is provided in the fence and the opening corresponds to the first opening of the fixed bowl cover.

12. The pet feeder according to claim 1, wherein, the plurality of housing cells comprise disposable housing cells.
